(19) United States
(12) Patent Application Publication
(10) Pub. No.: US 2010/0139695 A1
(43) Pub. Date: Jun. 10, 2010

(54) Dosage Element and a Method of Manufacturing a Dosage Element

(75) Inventors: Ralf Wiedemann, Mira (IT); Pavlinka Roy, Ludwigshafen (DE); Frederic Moreux, Barcelona (ES)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser N.V., Hoolddorp (NL)

(21) Appl. No.: 12/523,573

(22) PCT Filed: Jan. 17, 2008
(86) PCT No.: PCT/GB2008/000161

§ 371 Date: Jan. 13, 2010

(30) Foreign Application Priority Data
Jan. 18, 2007 (GB) 0700929.3

(51) Int. Cl. A47L 15/44; B29C 31/04

(52) U.S. Cl. 134/18; 264/251

(57) ABSTRACT

A dosage element of a type to be consumed in use in a ware washing machine comprises an outer casing formed during a preliminary manufacturing process, whereby said outer casing is provided with two compartments respectively containing first and second substances, the two compartments being separated by an insert which forms one or more internal separation walls.

The invention relates to a dosage element for a ware washing machine and to a method of manufacture thereof.

Ware washing machines, such as automatic clothes washing and dishwashing machines, typically utilise detergents and other additives in solid, liquid or powdered form. These substances are either administered directly into the machine, or dispensed via a tray or a dedicated compartment system to be added to the washing area at the start of, or during, a washing cycle.

Often, the required detergents/additives are administered as a compound tablet comprising a plurality of active ingredients. These may be kept separate for reasons of incompatibility. Alternatively or additionally they may be kept separate so that they may be activated at different points during a washing cycle or rinsing cycle. This activation at a particular point may be achieved by including time and/or temperature dependent released elements within the composition. One technique involves the coating or encasing of individual active components of the compound tablet within a water soluble polymer or gel of given properties/thickness to provide a time delayed and/or temperature dependent exposure to the component within so that it is exposed to the wash liquor within the ware washing machine at the desired point in a cycle.

In compound dosage elements of the type described above, individual active components may be in any state such as a solid, particulate or liquid form.

With the need to accommodate perhaps three or four active components within a single convenient dosage element, comes the complication of isolating each component from its' neighbour and providing the tablet within an overall compact package. These issues lead to complications within the manufacturing process and an increase in the costs of production. Accordingly, it is one aim of preferred embodiments of the present invention to provide a relatively simple dosage element formation and uncomplicated method of construction

Consumers are becoming increasingly reluctant to handle detergent compositions directly as there are perceived health/hygiene issues to doing so. With this in mind, it is desired to provide a barrier between the hand of the consumer and the ingredients of the dosage element and to reduce the risks of inadvertent exposure of the consumer to active ingredients of the tablet.

According to a first aspect of the invention, there is provided a dosage element to be consumed in use in a ware washing machine, the dosage element comprising an outer casing formed during a preliminary manufacturing process, whereby said outer casing is provided with two compartments respectively containing first and second substances, the two compartments being separated by an insert which forms one or more internal separation walls.

In the present invention the dosage element is suitably consumed in a washing cycle, in the sense that at the end of cycle no part of it has to be removed from the machine; indeed, preferably, no part of it can be discerned, within the machine.

Suitably the insert is manufactured separately from the outer casing.

Preferably the insert is sealed to the inside walls of the outer casing.

Preferably the insert comprises a generally planar wall which, optionally, may carry or encapsulate a third substance. Preferably the planar wall surrounds a core or capsule of the third substance.

The outer casing may be manufactured with an opening instead of one wall, and the insert may be introduced into the outer casing through that opening. That opening may also be the route for the delivery of said substances into the dosage element.

Such an opening, for the introduction of said insert and/or of said substances, is preferable closed by a lid, preferably in the form of a film.

Optionally, said insert carries or encapsulates a third substance.

Preferably, said outer casing includes a guide portion for the reception of said insert at a predetermined location.

In first embodiments said guide portion preferably comprises a groove or grooves formed in at least one wall of said outer casing. Groove(s) may be formed in opposed walls of said outer casing or may be formed in one or both opposed walls and/or in a floor portion. A groove may be a continuous or discontinuous groove. In one embodiment just the opposed walls may each have a groove, one opposed to the other. In another just the floor portion may have a groove.

A groove or groove may serve as a guide or locator to ensure correct positioning on the insert and/or to aid its insertion.

A groove or grooves may aid sealing of the insert to the outer casing but is not essential: edge-to-face sealing under suitable conditions of heat and pressure is feasible.

In a second embodiment, said guide portion comprises a step discontinuity formed within the outer casing to make a ledge on which said insert may be laid so as to separate the outer casing into said plurality of compartments. Said ledge preferably defines an upper limit of a lower compartment of said outer casing.

Preferably, during manufacture of said dosage element, a first substance is introduced into said lower compartment prior to laying the insert onto said ledge. Preferably, subsequent to laying the insert, a second substance is introduced above said insert.

In the second embodiment, again said insert may carry or encapsulate a third substance.

In a third embodiment, the outer casing may be formed into two portions during said preliminary manufacturing process and arranged so as to sandwich the insert between opposed open parts of said outer casing so as to form separate pockets of said dosage element. Here, preferably, said outer casing is formed as left and right hand parts which are arranged to trap the insert between them. In this manner, a compartment defined by the inner space between the left hand part of the outer casing and a first side of said insert may contain a first substance, and a compartment defined by the inner space between the right hand part of the outer casing and a second side of said insert may contain a second substance. In this embodiment a lid, for example a film, may not be needed, if the portions are of shell-half form, which form an enclosure when brought together.

Each of the first and second parts may have a peripheral region, and the peripheral regions are arranged face-to-face when the parts are brought together for closing of the receptacle. These regions are suitably the means by which the first and second parts are joined. They are sealed to each other in face-to-face relation, in the finished dosage element. Thus, the dosage element suitably has a peripheral skirt, which represents the sealing zone.

Preferably, a first substance is enclosed within a compartment defined between one side of the insert and the inside of the outer casing, whilst a second substance is enclosed within a compartment defined between a second side of the insert and the inside of the outer casing.

Suitably, the constituent parts are brought together during a manufacturing step. Preferably the end result is a dosage element in which each part supports the other part so as to reduce the likelihood of damage to the respective substances, for example during manufacturing, packing, handling or transportation.

The substances referred to herein may suitably comprise a liquid, or a flowable solid such as a powder, or a flowable or pumpable gel.

Preferably the wall materials of and within the dosage element are of water-soluble polymeric material(s). The materials thereof may be the same or different. In many embodiments they will be of the same grade and/or thickness but the invention does offer the prospect of supplying a dosage form having differential rates of release of different substances, arising from selection of different wall materials. Thus the walls of the first part could be selected to be fast to dissolve and the walls of the second part could be selected to be slower to dissolve. The second part might usefully then be the vehicle for delivery of, for example, a rinse aid.

Water-soluble herein includes water-dispersible.

Preferably, the walls and/or compartments of the outer casing are made by thermoforming water-soluble sheets or films, but could be formed by injection moulding.

Preferably the walls and/or compartments of the outer casing are of a material which is flexible, in the sense that when subjected to a deflecting force it does not generate a force acting to restore it to its previous position or shape (as would a “flexible” plastics ruler). Nevertheless when joined to one another in peripheral regions and filled with compositions the end result is a stable dosage element.

Wall and divider parts may be sealed together by means of an adhesive, preferably an aqueous liquid, preferably a PVOH solution or water. The adhesive may be applied to one of both peripheral regions. Alternatively they may be sealed together by heat sealing. Other methods of sealing include infra-red, radio frequency, ultrasonic, laser, solvent (such as water), vibration and spin welding. If heat sealing is used, a suitable sealing temperature is for example 125° C. A suitable sealing pressure is readily selected by the person skilled in the art.

Preferably, the walls of, or within, the outer casing are of film or sheet material having a thickness of between 30 and 600 μm. When thermoforming is used, the thickness is preferably in the range 30-250 μm, preferably 40-200 μm, preferably 50-150 μm. When injection moulding is used, the thickness is preferably in the range 200-600 μm, preferably 240-600 μm preferably 250-400 μm.

The insert could, however, be thicker, for example up to 2000 μm, for example up to 1000 μm. It could, for example, be of calendered, injection moulded or extruded sheet material.

Suitable water-soluble polymeric materials for use in this invention are such that discs of 100 μm thickness and 30 mm diameter dissolve in 5 litres of water maintained at 50° C., under gentle stirring, in less than 30 minutes.

A water-soluble polymeric material for use herein may suitably be selected from the group comprising polyvinyl alcohols, polyvinyl alcohol copolymers, partially hydrolyzed polyvinyl acetates, cellulose derivatives (such as alkylcelluloses, hydroxyalkylcelluloses, salts, ethers and esters of alkylcelluloses and hydroxyalkylcelluloses, for example, hydroxypropylcellulose, hydroxypropylmethyl-cellulose and sodium carboxymethylcellulose); polyglycolides, polyglycolic acids, polylactides, polylactic acids; polyvinyl pyrrolidines, polyacrylic acids or salts or esters thereof, polymaleic acids or salts or esters thereof, dextrins, maltodextrins, polyacrylamides, acrylic acid/maleic anhydride copolymers, including copolymers (which includes terpolymers), and blends. Optionally fillers, plasticisers and process aids may also be comprised in the formulation of a water-soluble polymeric material for use herein.

Preferred polymeric materials for are selected from the group comprising polyvinyl alcohols, polyvinyl alcohol copolymers, and partially hydrolyzed polyvinyl acetates. An especially preferred water-soluble polymeric material comprises a poly(vinyl alcohol).

Preferably the dosage element is not of squared-off, cuboid appearance and/or is preferably not rigid. Preferably is not box-like, in look or feel. Preferably it is of somewhat rounded, preferably pillow-like appearance, and/or is of compliant or “squashy” feel.

A preferred dosage form of the invention is a laundry washing tablet or, most preferably, a dishwashing tablet. We use the term tablet here to denote a body which can be handled by a consumer as a discrete element, for example as a unit dose. Preferably the first and second substances comprise laundry detergent compositions, or, especially, dishwashing detergent compositions.

Preferred components of a dishwashing tablet are as follows:

### Bleaching Compounds

Any type of bleaching compound conventionally used in detergent compositions may be used according to the present invention. Preferably the bleaching compound is selected from inorganic peroxides or organic peracids, derivatives thereof (including their salts) and mixtures thereof. Especially preferred inorganic peroxides are percarbonates, perborates and persulphates with their sodium and potassium salts being most preferred. Sodium percarbonate and sodium perborate are most preferred, especially sodium percarbonate.

Organic peracids include all organic peracids traditionally used as bleaches, including, for example, perbenzoic acid and peroxycarboxylic acids such as mono- or diperoxyphthalic acid, 2-octyldiperoxysuccinic acid, diperoxydodecanedicarboxylic acid, diperoxy-azelaic acid and imidoperoxycarboxylic acid and, optionally, the salts thereof. Especially preferred is phthalimidoperhexanoic acid (PAP).

Desirably the bleaching compound is present in the compositions in an amount of from 1 to 60 wt %, especially 5 to 55 wt %, most preferably 10 to 50% wt, such as 10 to 20% wt. When the compositions of the invention comprise two or more distinct regions, the amount of bleaching compound typically present in each can be chosen as desired although the total amount of the bleaching compound will typically be within the amounts stated hereinabove.

### Builders

The detergent compositions may also comprise conventional amounts of detergent builders which may be either phosphorous based or non-phosphorous based, or even a combination of both types. Suitable builders are well known in the art.

If phosphorous builders are to be used then it is preferred that mono-phosphates, di-phosphates, tri-polyphosphates or oligomeric-polyphosphates are used. The alkali metal salts of these compounds are preferred, in particular the sodium salts. An especially preferred builder is sodium tripolyphosphate (STPP).

The non-phosphorous based builder may be organic molecules with carboxylic group(s), amino acid based compound or a succinate based compound. The term ‘succinate based compound’ and ‘succinic acid based compound’ are used interchangeably herein.

Builder compounds which are organic molecules containing carboxylic groups include citric acid, fumaric acid, tartaric acid, maleic acid, lactic acid and salts thereof. In particular the alkali or alkaline earth metal salts of these organic compounds may be used, and especially the sodium salts. An especially preferred builder is sodium citrate.

Preferred examples of amino acid based compounds according to the invention are MGDA (methyl-glycine-diacetic acid, and salts and derivatives thereof) and GLDA (glutamic-N,N-diacetic acid and salts and derivatives thereof). GLDA (salts and derivatives thereof) is especially preferred according to the invention, with the tetrasodium salt thereof being especially preferred. Other suitable builders are described in U.S. Pat. No. 6,426,229 which is incorporated by reference herein. Particular suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), α-alanine-N,N-diacetic acid (α-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA) and alkali metal salts or ammonium salts thereof.

Further preferred succinate compounds are described in U.S. Pat. No. 5,977,053 and have the formula;

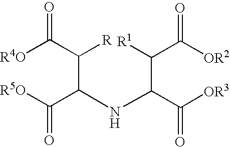

in which R, R¹, independently of one another, denote H or OH, R², R³, R⁴, R⁵, independently of one another, denote a cation, hydrogen, alkali metal ions and ammonium ions, ammonium ions having the general formula R⁶R⁷R⁸R⁹N+ and R⁶, R⁷, R⁸, R⁹, independently of one another, denoting hydrogen, alkyl radicals having 1 to 12 C atoms or hydroxyl-substituted alkyl radicals having 2 to 3 C atoms. A preferred example is tetrasodium imminosuccinate.

Preferably the total amount of builder present in the compositions of the invention is an amount of at least 5 wt %, preferably at least 10 wt %, more preferably at least 20 wt %, and most preferably at least 25 wt %, preferably in an amount of up to 70 wt %, preferably up to 65 wt %, more preferably up to 60 wt %, and most preferably up to 35 wt %. The actual amount used will depend upon the nature of the builder used.

The detergent compositions of the invention may further comprise a secondary builder (or cobuilder). Preferred secondary builders include homopolymers and copolymers of polycarboxylic acids and their partially or completely neutralized salts, monomeric polycarboxylic acids and hydroxycarboxylic acids and their salts, phosphates and phosphonates, and mixtures of such substances. Preferred salts of the abovementioned compounds are the ammonium and/or alkali metal salts, i.e. the lithium, sodium, and potassium salts, and particularly preferred salts is the sodium salts.

Secondary builders which are organic are preferred.

Suitable polycarboxylic acids are acyclic, alicyclic, heterocyclic and aromatic carboxylic acids, in which case they contain at least two carboxyl groups which are in each case separated from one another by, preferably, no more than two carbon atoms.

Polycarboxylates which comprise two carboxyl groups include, for example, water-soluble salts of, malonic acid, (ethylenedioxy)diacetic acid, maleic acid, diglycolic acid, tartaric acid, tartronic acid and fumaric acid. Polycarboxylates which contain three carboxyl groups include, for example, water-soluble citrate. Correspondingly, a suitable hydroxycarboxylic acid is, for example, citric acid.

Another suitable polycarboxylic acid is the homopolymer of acrylic acid. Other suitable builders are disclosed in WO 95/01416, to the contents of which express reference is hereby made.

### Surfactants

The detergent compositions of the invention may contain surface active agents, for example, anionic, cationic, amphoteric or zwitterionic surface active agents or mixtures thereof. Many such surfactants are described in Kirk Othmer's Encyclopedia of Chemical Technology, 3rd Ed., Vol. 22, pp. 360-379, “Surfactants and Detersive Systems”, incorporated by reference herein. In general, bleach-stable surfactants are preferred.

A preferred class of nonionic surfactants is ethoxylated non-ionic surfactants prepared by the reaction of a monohydroxy alkanol or alkylphenol with 6 to 20 carbon atoms. Preferably the surfactants have at least 12 moles particularly preferred at least 16 moles, and still more preferred at least 20 moles of ethylene oxide per mole of alcohol or alkylphenol.

Particularly preferred non-ionic surfactants are the non-ionics from a linear chain fatty alcohol with 16-20 carbon atoms and at least 12 moles particularly preferred at least 16 and still more preferred at least 20 moles of ethylene oxide per mole of alcohol.

According to one embodiment of the invention, the non-ionic surfactants additionally may comprise propylene oxide units in the molecule. Preferably these PO units constitute up to 25% by weight, preferably up to 20% by weight and still more preferably up to 15% by weight of the overall molecular weight of the non-ionic surfactant.

Surfactants which are ethoxylated mono-hydroxy alkanols or alkylphenols, which additionally comprises polyoxyethylene-polyoxypropylene block copolymer units may be used. The alcohol or alkylphenol portion of such surfactants constitutes more than 30%, preferably more than 50%, more preferably more than 70% by weight of the overall molecular weight of the non-ionic surfactant.

Another class of suitable non-ionic surfactants includes reverse block copolymers of polyoxyethylene and polyoxypropylene and block copolymers of polyoxyethylene and polyoxypropylene initiated with trimethylolpropane.

Another preferred class of nonionic surfactant can be described by the formula:

R¹O[CH₂CH(CH₃)O]_{X}[CH₂CH₂O]_{Y}[CH₂CH(OH)R²]

where R¹ represents a linear or branched chain aliphatic hydrocarbon group with 4-18 carbon atoms or mixtures thereof, R² represents a linear or branched chain aliphatic hydrocarbon rest with 2-26 carbon atoms or mixtures thereof, x is a value between 0.5 and 1.5 and y is a value of at least 15.

Another group of preferred nonionic surfactants are the end-capped polyoxyalkylated non-ionics of formula:

R¹O[CH₂CH(R³)O]_{X}[CH₂]ₖCH(OH)[CH₂]ⱼOR²

where R¹ and R² represent linear or branched chain, saturated or unsaturated, aliphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R³ in the formula above can be different. R¹ and R² are preferably linear or branched chain, saturated or unsaturated, aliphatic or aromatic hydrocarbon groups with 6-22 carbon atoms, where group with 8 to 18 carbon atoms are particularly preferred. For the group R³H, methyl or ethyl are particularly preferred. Particularly preferred values for x are comprised between 1 and 20, preferably between 6 and 15.

As described above, in case x>2, each R³ in the formula can be different. For instance, when x=3, the group R³ could be chosen to build ethylene oxide (R³═H) or propylene oxide (R³=methyl) units which can be used in every single order for instance (PO)(EO)(EO), (EO)(PO)(EO), (EO)(EO)(PO), (EO)(EO)(EO), (PO)(EO)(PO), (PO)(PO)(EO) and (PO)(PO)(PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R¹O[CH₂CH(R³)O]_{X}CH₂CH(OH)CH₂OR²

The use of mixtures of different nonionic surfactants is suitable in the context of the present invention, for instance, mixtures of alkoxylated alcohols and hydroxy group containing alkoxylated alcohols.

Other suitable surfactants are disclosed in WO 95/01416, to the contents of which express reference is hereby made.

Preferably the non-ionic surfactants are present in the compositions of the invention in an amount of from 0.1% wt to 5% wt, more preferably 0.5% wt to 3% wt, such as 0.5 to 3% wt.

The surfactants are typically included in amounts of up to 15% wt, preferably of from 0.5% wt to 10% wt, such as 1% wt to 5% wt in total.

### Anti-Foam Agents

The detergent composition according to the invention may comprise one or more foam control agents. Suitable foam control agents for this purpose are all those conventionally used in this field, such as, for example, silicones and paraffin oil. If present, the foam control agents are preferably present in the composition in amounts of 5% by weight or less of the total weight of the composition.

### Anti-Corrosion Agents

It is known to include a source of multivalent ions in cleaning compositions, and in particular in automatic dishwashing compositions, for technical and/or performance reasons. For example, multivalent ions and especially zinc and/or manganese ions have been included for their ability to inhibit corrosion on metal and/or glass. Bismuth ions may also have benefits when included in such compositions.

For example, organic and inorganic redox-active substances which are known as suitable for use as silver/copper corrosion inhibitors are mentioned in WO 94/26860 and WO 94/26859. Suitable inorganic redox-active substances are, for example, metal salts and/or metal complexes chosen from the group consisting of zinc, manganese, titanium, zirconium, hafnium, vanadium, cobalt and cerium salts and/or complexes, the metals being in one of the oxidation states II, III, IV, V or VI. Particularly suitable metal salts and/or metal complexes are chosen from the group consisting of MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₂)₂ and Ce(NO₃)₃. Zinc salts are specially preferred corrosion inhibitors.

Therefore, an especially preferred optional ingredient according to the present invention is a source of multivalent ions such as those mentioned in the immediately preceding paragraph and in particular zinc, bismuth and/or manganese ions. In particular a source of zinc ions is preferred. Any suitable source of multivalent ions may be used, with the source preferably being chosen from sulphates, carbonates, acetates, gluconates and metal-protein compounds and those mentioned in the immediately preceding paragraph.

Any conventional amount of multivalent ions/multivalent ions source may be included in the compositions of the invention. However, it is preferred that the multivalent ions are present in an amount of from 0.01% wt to 5% wt, preferably 0.1% wt to 3% wt, such as 0.5% wt to 2.5% wt. The amount of multivalent ion source in the compositions of the invention will thus be correspondingly higher.

The detergent composition may also comprise a silver/copper corrosion inhibitor in conventional amounts. This term encompasses agents that are intended to prevent or reduce the tarnishing of non-ferrous metals, in particular of silver and copper. Preferred silver/copper corrosion inhibitors are benzotriazole or bis-benzotriazole and substituted derivatives thereof. Other suitable agents are organic and/or inorganic redox-active substances and paraffin oil. Benzotriazole derivatives are those compounds in which the available substitution sites on the aromatic ring are partially or completely substituted. Suitable substituents are linear or branch-chain C₁₋₂₀ alkyl groups and hydroxyl, thio, phenyl or halogen such as fluorine, chlorine, bromine and iodine. A preferred substituted benzotriazole is tolyltriazole.

### Performance Polymers

Polymers intended to improve the cleaning performance of the detergent compositions may also be included therein. For example sulphonated polymers may be used. Preferred examples include copolymers of CH₂═CR¹—CR²R³—O—C₄H₃R⁴—SO₃X wherein R¹, R², R³, R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulfonated monomers for incorporation in sulfonated (co)polymers are 2-acrylamido-2-methyl-1-propanesulfonic acid, 2-methacrylamido-2-methyl-1-propanesulfonic acid, 3-methacrylamido-2-hydroxy-propanesulfonic acid, allysulfonic acid, methallysulfonic acid, 2-hydroxy-3-(2-propenyloxy)propanesulfonic acid, 2-methyl-2-propenen-1-sulfonic acid, styrenesulfonic acid, vinylsulfonic acid, 3-sulfopropyl acrylate, 3-sulfopropylmethacrylate, sulfomethylacrylamide, sulfomethylmethacrylamide and water soluble salts thereof. Suitable sulfonated polymers are also described in U.S. Pat. No. 5,308,532 and in WO 2005/090541.

When a sulfonated polymer is present, it is preferably present in the composition in an amount of at least 0.1 wt %, preferably at least 0.5 wt %, more preferably at least 1 wt %, and most preferably at least 3 wt %, up to 40 wt %, preferably up to 25 wt %, more preferably up to 15 wt %, and most preferably up to 10 wt %.

### Enzymes

The detergent composition of the invention may comprise one or more enzymes. It is preferred that the enzyme is selected from protease, lipase, amylase, cellulase and peroxidase enzymes. Such enzymes are commercially available and sold, for example, under the registered trade marks Esperase, Alcalase and Savinase by Nova Industries A/S and Maxatase by International Biosynthetics, Inc. It is most preferred that protease enzymes are included in the compositions according to the invention; such enzymes are effective for example in dishwashing detergent compostitions.

Desirably enzyme(s) is/are present in the composition in an amount of from 0.01 to 3 wt %, especially 0.1 to 2.5 wt %, such as 0.2 to 2 wt %.

### Buffering Systems

The detergent composition according to the invention may comprise a buffering system to maintain the pH of the composition at a desired pH on dissolution and this may comprise a source of acidity or a source of alkalinity as necessary.

A source of acidity may suitably be any components which are acidic; for example polycarboxylic acids. Citric acid is especially preferred. Salts of these acids may also be used. A source of alkalinity may suitably be any suitable compound which is basic; for example any salt of a strong base and a weak acid such as soda. However additional acids or bases may be present. In the case of alkaline compositions silicates, phosphates or hydrogen phosphates may suitably be used. Preferred silicates are sodium silicates such as sodium disilicate, sodium metasilicate and crystalline phyllosilicates.

### Perfume, Colours, Preservatives

The detergent compositions of the invention may also comprise minor, conventional amounts of perfumes, preservatives and/or colourants. Such ingredients are typically present in amounts of up to 2% wt.

### Contrasting Parts

Preferred dosage forms have first and second parts which contrast with each other. They may contrast in the chemical nature of their components. The components may have different functions in a ware washing environment. They may be incompatible with each other. For example one component may interact adversely with another component to cause instability in storage or to reduce effective cleaning action, and such components may be segregated, one in the first part and one in the second part.

Alternatively or additionally the first and second parts may be arranged to release their components at different times in the washing process. This may be achieved by use of different coverings or skins for the components; for example by use of different wall materials for the first and second parts, with different rates of dissolution in the wash water and/or by use of walls of different thicknesses for the first and second parts.

Alternatively or additionally it may facilitate manufacture to separate certain components, and thereby create a contrast between the first and second parts.

Alternatively or additionally the first and second parts may contrast in their properties for aesthetic reasons. The following are examples of contrasting first and second parts:

an enzyme in one part and a bleach in another part;
a corrosion inhibitor in one part and a bleach in another part;
a corrosion inhibitor in one part and an enzyme in another part;
an acid or a hydrolysable agent in one part and an alkalinity agent in another part;
a solid (including a powder or a gel) in one part and a liquid in another part;
a solid (including a powder or a gel) in one part and another solid (including a powder or a gel) in another part, to be kept apart, whether for chemical/functional reasons or aesthetic reasons;
a liquid in one part and another liquid in another part, to be kept apart, whether for chemical/functional reasons or aesthetic reasons;
a pre-wash formulation (including a ware washing machine cleaner, for example machine sanitizer and/or descaler), in one part and a main wash formulation in another part;
a main wash formulation in one part and a rinse aid formulation in another part.

It is an important advantage of this invention that it offers the opportunity to provide a dosage element having a plurality of compartments but formed by a different approach to the conventional, and giving new, flexible design possibilities.

Preferably the weight of the dosage element is up to 34 g, preferably up to 30 g.

Preferably the weight of the dosage element is at least 4 g, preferably at least 10 g, preferably at least 14 g.

Preferably the ratio by weight of the said substances contained in the dosage element to the total water-soluble polymeric material(s) (the sum thereof making up the total weight of the dosage element) is in the range 10:1 to 100:1, preferably 16:1 to 60:1, preferably 24:1 to 40:1.

Preferably the weight of the total water-soluble polymeric material(s) is at least 0.1 g, preferably at least 0.2 g, preferably at least 0.3 g.

Preferably the weight of the total water-soluble polymeric material(s) is up to 2 g, preferably up to 1 g, preferably up to 0.7 g.

Preferably the volume of the first compartment is 50-200% of the volume of the second compartment, preferably 70-150%, preferably 85-120%.

Preferably the volume of the third compartment (when present) is 5-80% of the volume of the first compartment, preferably 10-50%, preferably 15-30%.

According to a second aspect of the invention, there is provided a method of manufacturing a dosage element to be consumed in use in a ware washing machine, the method comprising:

(a) forming an outer casing as a pocket in a mould;
(b) forming an insert;
(c) placing said insert into the mould so as to divide the outer casing into a plurality of separate compartments;
(d) introducing substances into the compartments of said dosage element; and
(e) capping and sealing said dosage element to close and seal said compartments.

Preferably, step (a) includes the formation of guide portions within said mould, said guide portions being arranged to define the positioning of said insert, said guide portions may be defined by one or more grooves in the mould.

A third aspect of the invention provides a method of manufacturing a dosage element to be consumed in use in a ware washing machine, the method comprises the steps of:

(a) forming an outer casing as a pocket in a mould;
(b) forming an insert;
(c) introducing a first substance into a lowermost part of said pocket;
(d) placing said insert into the mould and above said first substance so as to divide the outer casing into a plurality of separate compartments;
(e) introducing a second substance above said insert; and
(f) capping and sealing said dosage element to close and seal said compartments.

Preferably, step (a) includes the formation of a step discontinuity within said mould so as to provide a ledge, the location of which marks an uppermost boundary of the lowermost part of said pocket.

Preferably, in step (d), the insert is placed such that edge portions thereof rest on and are supported by said ledge.

In a fourth aspect of the invention, there is provided a method of manufacturing a dosage element to be consumed in use in a ware washing machine, the method comprising:

(a) forming left and right hand side part outer casings;
(b) forming an insert;
(c) sandwiching said insert between said left and right hand side part outer casings so as to divide the compound outer casing thus produced into a plurality of separate compartments;
(d) introducing a first substance into the compartment formed between an inner surface of the left part casing and a first side of the insert;
(e) introducing a second substance into the compartment formed between an inner surface of the right part casing and a second side of the insert;
(f) capping and sealing said dosage element to close and seal said compartments.

Preferably, in any of the aforementioned methods a mould is employed comprising a plurality of cavities for forming a plurality of outer casings or part outer casings at one time.

The method preferably comprises completing the manufacture of a plurality of dosage elements at on time as a matrix of dosage elements, including the step of separating the completed dosage elements into individual dosage elements or into groups of dosage elements, for example 4-16 in number, which are packaged in such groups and are intended to be separated into individual dosage elements by the user.

After the steps described above the dosage elements may be packaged.

Preferably the steps described above define the manufacturing method fully; that is, there is preferably no further substantive manufacturing step. In particular there is for example preferably no step of setting the dosage elements face-to-face, for example by folding.

The dosage element of the first aspect need not be made by the method of the second, third or fourth aspect. Nevertheless preferred aspects defined with reference to the second, third or fourth aspect may (unless not possible) be regarded as preferred aspects of the first aspect whether or not made by the method of the second, third or fourth aspect; and vice-versa.

However, the dosage element of the first aspect is preferably made by the method of the second, third or fourth aspect. In a fifth aspect of the invention there is provided a dosage element made by a method of the second, third or fourth aspect.

According to a sixth aspect there is provided a method of ware washing in a machine, preferably a method of washing kitchenware in a dishwashing machine, using a dosage element of the first aspect, or a dosage element of the fifth aspect. In this method the dosage element is wholly consumed in one wash cycle.

For a better understanding of the invention, and to show how embodiments of the same may be carried into effect, reference will now be made, by way of example, to the accompanying diagrammatic drawings in which:

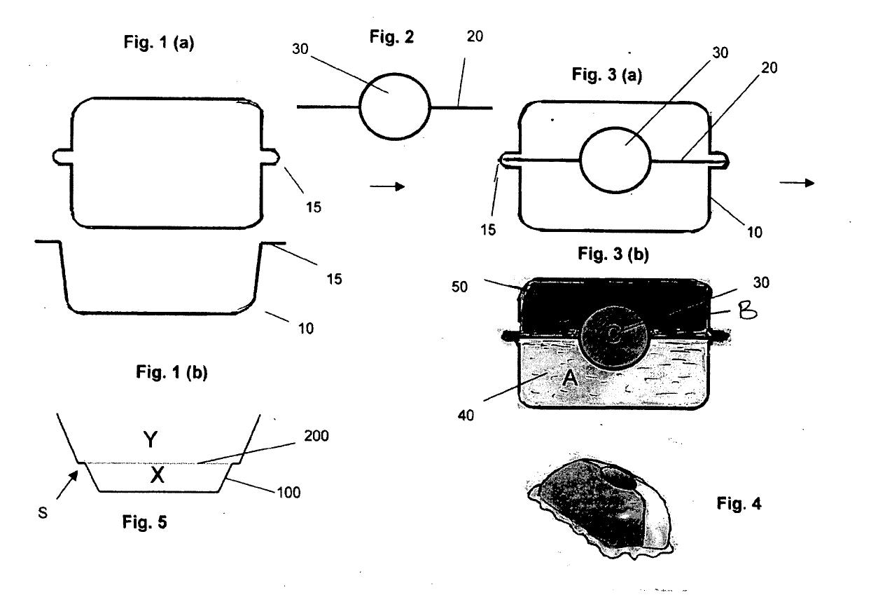

FIG. 1(a) is a schematic diagram showing a top view of an outer casing for use in a dosage element according to a first embodiment of the invention;

FIG. 1(b) is a schematic side view of the outer casing of FIG. 1(a);

FIG. 2 is a schematic end view showing an insert for use in the dosage element of the first embodiment;

FIG. 3(a) is a schematic top view showing a dosage element in accordance with the first embodiment in a state in which the insert and outer casing have been assembled prior to filling and sealing;

FIG. 3(b) is a view showing the dosage element of FIG. 3(a) in a filled but unsealed state;

FIG. 4 is a perspective view of a completed, filled and sealed dosage element in accordance with the first embodiment; and

FIG. 5 illustrates a variation in a production method for a dosage element in accordance with the invention.

Referring to FIGS. 1 to 4 there will now be described a dosage element in accordance with a first embodiment of the invention and a method of manufacture thereof.

FIGS. 1(a) and 1(b) show top and side views respectively of an outer casing 10 for a dosage element. The casing 10 forms an open pocket having a groove portion 15 formed within it. The groove portion may be a continuous groove, running from side to bottom to side of the casing, or may be, for instance, formed from two grooves on opposed sides of the casing. The purpose of the grooving is common to all cases in that the groove or grooves form a guide region in which an insert 20 may be placed.

One form of insert 20 is shown in FIG. 2 in end view. The insert 20 consists of a generally planar wall which (optionally) may carry or encapsulate a core 30.

As shown in FIG. 3(a), the insert 20, in use, is arranged to locate inside the pocket formed by the outer casing 10 by means of inserting peripheral areas of the insert into the guide region formed by the groove portion 15. The outer shape of the insert 20 conforms to the shape of the casing 10/groove portion 15 and when pushed fully home forms a partition wall within the outer casing 10 so as to divide it into chambers which are isolated from one another.

Referring now to FIG. 3(b), the chambers formed by insert 20 and casing 10 may be indicated as chambers 40, 50. Here, chamber 40 may be then filled with a first substance A, chamber 50 formed with a second substance B, and, where there is a core 30 present, this may be a third substance C. All wall materials comprise water-soluble PVOH.

In this embodiment, the material forming the outer casing 10 may typically be a thermoformed sheet material such as PVOH formed in a suitable mould, whilst the material for the insert 20 is typically an injection moulded plastics material, both materials being water soluble.

Where present, the core 30 may be either attached by a suitable adhesive substance directly to the insert 20 so as to sit to one side of it, or it may be encapsulated within the insert 20 by, for instance, forming the insert from two opposed sheets or films and bringing them together to sandwich the core 30 between them.

Finally, to produce the form of dosage element as shown in FIG. 4, the filled pocket arrangement of FIG. 3(b) is capped by a top film (not shown) and the parts sealed.

The preferred process, in detail, for forming a dosage element in accordance with the above construction is as described below in steps (A) through (F).

(A) Forming the outer casing 10 into a pocket, by thermoforming in the cavity of a thermoforming mould. A suitable forming temperature for PVOH is, for example, 120° C. The thickness of the film used to produce the pocket is preferably 90 to 120 μm. A suitable forming vacuum is 0 to 2 kPa.

(B) Introducing the insert 20 into the thermoforming mould to form an internal partition wall between first and second parts of the outer casing 10. This insert 20 can be an injection moulded water soluble article. The thermoforming mould is designed in order to clamp the insert 20 to the outer casing 10 by means of bevelled edges to form a snug fit between the parts and avoid any transmission of contents between the different chambers formed. The thickness of the rigid film used to produce the insert 20 which forms the internal partition is preferably 350 μm.

(C) Introducing contents into the chambers formed between the outer casing 10 and the insert 20 into the pocket; and

(D) Adding a covering top film to the mould. The thickness of the covering film is generally 60 to 75 μm in this embodiment.

(E) Sealing the films of the dosage element by any suitable means, for example by means of an adhesive or by heat sealing. Other methods of sealing include infra-red, radio frequency, ultrasonic, laser, solvent (such as water), vibration and spin welding. An adhesive such as an aqueous solution of PVOH may also be used. The seal desirably is water-soluble if the containers are water-soluble. If heat sealing is used, a suitable sealing temperature is for example 125° C. A suitable sealing pressure is especially 500 to 700 kPa depending on the heat sealing machine used.

(F) Cutting to form the water-soluble article. (for example by HF or by mechanical punching).

Referring now to FIG. 5, there is shown a mould for forming a dosage element in accordance with a second embodiment of the invention.

Here, the mould has a formation in which there is formed a step or ledge “S”. This step means that an outer casing 100 may be formed into the mould taking the form of the mould as shown by the solid outline. Then in a next step, a bottom part of the outer casing below the step line S may be filled with a substance X. Thereafter, in a next manufacturing step a planar insert 200 may be placed over substance X and lie over it, supported by the ledge so as to adopt the position shown by the broken line in the figure. In a further step, a next substance Y may be introduced to the mould so as to overlie the insert 200. Finally, the dosage element may be completed by capping with a top film (not shown) and sealing.

In this second embodiment, it will be appreciated that the material of the outer casing 100 may be the same or similar to the material of the outer casing 10 of the first embodiment, whilst the material of the insert 200 may be the same or similar to the material of the insert 20. Substance X, may be from the same range as substance A, substance Y from the same range as substance B, and insert 200 may carry and encapsulate a core of material of a substance taken from the same or similar range of substances as substance C.

In a third variation, not shown, an embodiment is envisaged in which a first open pocket forms a left hand half of an outer casing, a second open pocket of the same or similar construction as the first open pocket forms a right hand half of the outer casing, and these two halves sandwich an insert having the construction of insert 20 or 200 between them. Here, the left and right halves may be filled with substances A, B, after the sandwich has been formed, and they may then be fully capped by a top film and sealed in the previously already described manner.

Suitable chemical compositions are as follows. In these examples the largest sub-composition (by weight) is in compartment, the next largest is in compartment B and the least is in compartment C. (see for reference FIG. 3(b)). In each example the PVOH was distributed, by weight, as follows: dividing wall 60%; side walls 30%; lid 10%.

### EXAMPLE 1

Phosphate-containing composition having percarbonate in a separate compartment (Table 1 below) for use in an automatic dishwasher.

TABLE 1

| | A - | C - | B - | Walls - |
|---|---|---|---|---|
| | Powder | Gel | Percarb. | PVOH |
| Raw Material | (8.4 g) | (6.4 g) | (1.3 g) | (1.0 g) |
| Sodium tripolyphosphate | 42.50 | | | |
| Sodium carbonate | 16.00 | | | |
| Tri-sodium citrate | 22.00 | | | |
| Phosphate speckles | 4.00 | | | |
| Benzotriazol | 0.40 | | | |
| HEDP 4 Na (88.5%) | 0.30 | | | |
| Protease¹ | 1.50 | | | |
| Amylase¹ | 1.00 | | | |
| TAED | 6.20 | | | |
| 1,2-Propylenediglycol | 0.98 | | | |
| Dye | 0.02 | | | |
| Perfume | 0.10 | | | |
| Sulfonated polymer² | 5.00 | | | |
| Sulfonated polymer² | | 5.00 | | |
| Surfactant³ | | 24.00 | | |
| Polyglycol⁴ | | 9.00 | | |
| 1,2-Propylendiglycol | | 1.00 | | |
| Dye | | 0.03 | | |
| Antifoam⁵ | | 0.25 | | |
| TAED | | 3.00 | | |
| Sodium tripolyphoshate | | 57.42 | | |
| Polyglycol 6000 | | 0.30 | | |
| Sodium percarbonate | | | 100 | |
| PVOH (substrate, | | | | 60 |
| pockets)⁷ | | | | |
| PVOH (lids)⁸ | 100 | | | 40 |
| | 100 | 100 | 100 | 100 |

### EXAMPLE 2

Phosphate-containing composition having PAP (phthalimido-hexanoic acid) (Table 2 below) in a separate compartment for use in an automatic dishwasher.

TABLE 2

| | A - | C - | B - | Walls - |
|---|---|---|---|---|
| | Powder | Gel | PAP | PVOH |
| Raw Material | (8.4 g) | (6.4 g) | (1.3 g) | (1.0 g) |
| Sodium tripolyphosphate | 48.70 | | | |
| Sodium carbonate | 16.00 | | | |
| Tri-sodium citrate | 22.00 | | | |
| Phosphate speckles | 4.00 | | | |
| Benzotriazol | 0.40 | | | |
| HEDP 4 Na (88.5%) | 0.30 | | | |
| Protease¹ | 1.50 | | | |
| Amylase¹ | 1.00 | | | |
| 1,2-Propylenediglycol | 0.98 | | | |
| Dye | 0.02 | | | |
| Perfume | 0.10 | | | |
| Sulfonated polymer² | 5.00 | | | |
| Sulfonated polymer² | | 5.00 | | |
| Surfactant³ | | 24.00 | | |
| Polyglycol⁴ | | 9.00 | | |
| 1,2-Propylendiglycol | | 1.00 | | |
| Dye | | 0.03 | | |
| Antifoam⁵ | | 0.25 | | |
| Sodium tripolyphoshate | | 60.42 | | |
| Polyglycol 6000 | | 0.30 | | |
| PAP⁶ | | | 100 | |
| PVOH (substrate, pockets)⁷ | | | | 60 |
| PVOH (lids)⁸ | | | | 40 |
| | 100 | 100 | 100 | 100 |

### EXAMPLE 3

Sodium citrate-containing composition having percarbonate in a separate compartment (Table 3 below) for use in an automatic dishwasher.

TABLE 3

| | A - | C - | B - | Walls - |
|---|---|---|---|---|
| | Powder | Gel | Percarb. | PVOH |
| Raw Material | (7.0 g) | (6.4 g) | (2.3 g) | (1.0 g) |
| Sodium carbonate | 16.00 | | | |
| Tri-sodium citrate | 68.50 | | | |
| Benzotriazol | 0.40 | | | |
| HEDP 4 Na (88.5%) | 0.30 | | | |
| Protease¹ | 1.50 | | | |
| Amylase¹ | 1.00 | | | |
| TAED | 6.20 | | | |
| 1,2-Propylenediglycol | 0.98 | | | |
| Dye | 0.02 | | | |
| Perfume | 0.10 | | | |
| Sulfonated polymer² | 5.00 | | | |
| Sulfonated polymer² | | 5.00 | | |
| Surfactant³ | | 24.00 | | |
| Polyglycol⁴ | | 9.00 | | |
| 1,2-Propylendiglycol | | 1.00 | | |
| Dye | | 0.03 | | |
| Antifoam⁵ | | 0.25 | | |
| TAED | | 3.00 | | |
| Tri-sodium citrate | | 56.72 | | |
| Polyglycol 35000 | | 1.00 | | |
| Sodium percarbonate | | | 100 | |
| PVOH (substrate, pockets)⁷ | | | | 60 |
| PVOH (lids)⁸ | | | | 40 |
| | 100 | 100 | 100 | 100 |

### EXAMPLE 4

Sodium citrate-containing composition having PAP in a separate compartment (Table 4 below) for use in an automatic dishwasher.

TABLE 4

| | A - | C - | B - | Walls - |
|---|---|---|---|---|
| | Powder | Gel | PAP | PVOH |
| Raw Material | (7.0 g) | (6.4 g) | (1.3 g) | (1.0 g) |
| Sodium carbonate | 16.00 | | | |
| Tri-sodium citrate | 74.70 | | | |
| Benzotriazol | 0.40 | | | |
| HEDP 4 Na (88.5%) | 0.30 | | | |
| Protease¹ | 1.50 | | | |
| Amylase¹ | 1.00 | | | |
| 1,2-Propylenediglycol | 0.98 | | | |
| Dye | 0.02 | | | |
| Perfume | 0.10 | | | |
| Sulfonated polymer² | 5.00 | | | |
| Sulfonated polymer² | | 5.00 | | |
| Surfactant³ | | 24.00 | | |
| Polyglycol⁴ | | 9.00 | | |
| 1,2-Propylendiglycol | | 1.00 | | |
| Dye | | 0.03 | | |
| Antifoam⁵ | | 0.25 | | |
| Tri-sodium citrate | | 59.72 | | |
| Polyglycol 35000 | | 1.00 | | |
| PAP⁶ | | | 100 | |
| PVOH (substrate, pockets)⁷ | | | | 60 |
| PVOH (lids)⁸ | | | | 40 |
| | 100 | 100 | 100 | 100 |

### EXAMPLE 5

MGDA-containing composition having PAP in a separate compartment (Table 5 below) for use in an automatic dishwasher.

TABLE 5

| | A - | C - | B - | Walls - |
|---|---|---|---|---|
| | Powder | Gel | PAP | PVOH |
| Raw Material | (6.0 g) | (6.4 g) | (1.3 g) | (1.0 g) |
| Sodium carbonate | 16.00 | | | |
| MGDA granules⁹ | 74.70 | | | |
| Benzotriazol | 0.40 | | | |
| HEDP 4 Na (88.5%) | 0.30 | | | |
| Protease¹ | 1.50 | | | |
| Amylase¹ | 1.00 | | | |
| 1,2-Propylenediglycol | 0.98 | | | |
| Dye | 0.02 | | | |
| Perfume | 0.10 | | | |
| Sulfonated polymer² | 5.00 | | | |
| Sulfonated polymer² | | 5.00 | | |
| Surfactant³ | | 24.00 | | |
| Polyglycol⁴ | | 9.00 | | |
| 1,2-Propylendiglycol | | 1.00 | | |
| Dye | | 0.03 | | |
| Antifoam⁵ | | 0.25 | | |
| MGDA granules⁹ | | 60.22 | | |
| Polyglycol 6000 | | 0.50 | | |
| PAP⁶ | | | 100 | |
| PVOH (substrate, pockets)⁷ | | | | 60 |
| PVOH (lids)⁸ | | | | 40 |
| | 100 | 100 | 100 | 100 |

### EXAMPLE 6

Sodium citrate-containing composition having PAP in a separate compartment (Table 6 below) for use in an automatic dishwasher.

TABLE 6

| | A - | C - | B - | Walls - |
|---|---|---|---|---|
| | Powder | Powder | PAP | PVOH |
| Raw Material | (7.0 g) | (7.0 g) | (1.3 g) | (1.0 g) |
| Sodium carbonate | 17.00 | 17.50 | | |
| Tri-sodium citrate | 68.50 | 68.50 | | |
| Benzotriazol | 0.40 | 0.40 | | |
| HEDP 4 Na (88.5%) | 0.30 | 0.30 | | |
| Protease¹ | 1.50 | | | |
| Amylase¹ | | 1.00 | | |
| TAED | 6.20 | 6.20 | | |
| 1,2-Propylenediglycol | 0.98 | 0.98 | | |
| Dye | 0.02 | 0.02 | | |
| Perfume | 0.10 | 0.10 | | |
| Sulfonated polymer² | 5.00 | 5.00 | | |
| Sodium percarbonate | | | 100 | |
| PVOH (substrate, pockets)⁷ | | | | 60 |
| PVOH (lids)⁸ | | | | 40 |
| | 100 | 100 | 100 | 100 |

In the above composition examples parts are by weight, and the following footnotes apply.

1 Granules which contain approx. 3-10% active enzyme
2 AMPS co-polymer
3 Non-ionic low foaming surfactant
4 Mixed poly alkoxylate grade, P 41/12000, Clariant

### 5 Silicon oil

6 PAP with particle size (Q50%<15 μm)
7 PVOH foil, 90 μm, PT grade from Aicello
8 PVOH foil, 60 μm, PT grade from Aicello
9 Sodium salt of methyl-glycine-diacetic acid

The container used in this example has 3 compartments separated from each other. In one compartment the PAP composition or the percarbonate composition is filled, respectively.

The powder is introduced into the powder compartment. The gel mixture is heated to 65° C. and stirred for 20 min. Then the gel is introduced into the gel compartment and is allowed to cool. Finally the compartments are sealed with PVOH film.

In the example the particle size of the PAP has preferably a size of 0.01-100 μm (Q50%<15 μm).

In all examples above illustrating the present invention the dosage element is consumed in a washing cycle, in the sense that at the end of cycle no part of it has to be removed from the machine; indeed no part of it can be discerned, within the machine.

Whilst three substances are discussed, the skilled man will realise that, according to a particular function to be performed, more or fewer substances may be utilised and combined in any logical combination without departing from the principles of the present invention.

The present invention as described above provides a very convenient and compact arrangement that is easy to manufacture, and subsequently which is resistant to bending and other stress. The invention offers design flexibility and the prospect of a range of attractive consumer products.

1. A ware washing dosage element comprising an outer casing comprising with two compartments respectively containing first and second substances, the two compartments being separated by an insert which forms one or more internal separation walls within the outer casing.

2. A dosage element according to claim 1, wherein said outer casing includes a guide portion for supporting said insert.

3. A dosage element according to claim 1, wherein said insert includes means for carrying or encapsulating a third substance.

4. A dosage element according to claim 1, wherein said dosage element is capped and sealed by a lid which covers the openings through which the first and second substances were introduced into the compartments.

5. A dosage element according to claim 2, wherein said guide portion comprises a groove formed in at least one wall of said outer casing.

6. A dosage element according to claim 1, wherein the outer casing includes a guide portion for supporting said insert, said guide portion comprises a step discontinuity formed within the outer casing defining a ledge on which said insert may be laid which insert separates the outer casing into said plurality of compartments.

7. (canceled)

8. A dosage element according to claim 1, wherein said outer casing is formed into two portions and is arranged sandwiching the insert between opposed open parts of said outer casing thus defining separate pockets of said dosage element.

9. A method of manufacturing a ware washing dosage element comprising the steps of:
(a) forming an outer casing as a pocket in a mould;
(b) forming an insert;
(c) placing said insert into the mould to divide the outer casing into a plurality of separate compartments;
(d) introducing substances into the compartments of said dosage element; and
(e) capping and sealing said dosage element to close and seal said compartments.

10. The method of claim 9, wherein step (a) further includes the formation of guide portions within said mould, said guide portions arranged to define the positioning of said insert.

11. A method of manufacturing a ware washing dosage element comprising the steps of:
(a) forming an outer casing as a pocket in a mould;
(b) forming an insert;
(c) introducing a first substance into a lowermost part of said pocket;
(d) placing said insert into the mould and above said first substance so as to divide the outer casing into a plurality of separate compartments;
(e) introducing a second substance above said insert; and
(f) capping and sealing said dosage element to close and seal said compartments.

12. A method of manufacturing a ware washing dosage element comprising the steps of:
(a) forming left and right hand side part outer casings;
(b) forming an insert;
(c) sandwiching said insert between said left and right hand side part outer casings dividing the compound outer casing thus produced into a plurality of separate compartments;
(d) introducing a first substance into the compartment formed between an inner surface of the left part casing and a first side of the insert;
(e) introducing a second substance into the compartment formed between an inner surface of the right part casing and a second side of the insert;
(f) capping and sealing said dosage element to close and seal said compartments.

13. A ware washing dosage element manufactured by a method according to claim 9.

14. A method of ware washing, comprising the steps of: providing the ware washing dosage element according to claim 1 to an automatic dishwasher;
providing wares to the automatic dishwasher;
operating the automatic dishwasher.

15. A ware washing dosage element according to claim 9, wherein the said ware washing dosage element is an automatic dishwashing dosage element.

16. A ware washing dosage element manufactured by a method according to claim 10.

17. A ware washing dosage element manufactured by a method according to claim 11.

18. A ware washing dosage element manufactured by a method according to claim 12.
